(19) United States
(12) Patent Application Publication
(10) Pub. No.: US 2007/0298650 A1
(43) Pub. Date: Dec. 27, 2007

(54) Intelligent screw supplier with auto-count and alarm function and method thereof

(75) Inventors: Tien-Chen Wei, Taipei City (TW); Chih-Yi Yen, Taipei City (TW); Kuo-Lung Kuo, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/730,107

(22) Filed: Mar. 29, 2007

(30) Foreign Application Priority Data
Jun. 26, 2006 (TW) 095122912

(51) Int. Cl. H01R 3/00

(52) U.S. Cl. 439/500

(57) ABSTRACT

An intelligent screw supplier operates with a first switch and a second switch. The intelligent screw supplier includes a screw supply machine and a screw supply controller. The screw supply machine is used for supplying screws. The screw supply controller includes a counter and a logic judgment device. The counter is used for calculating an amount of screws supplied by the screw supply machine. The logic judgment device is used for comparing the amount of screws calculated by the counter with a predetermined amount. The first switch is used for controlling the counter to start counting when the first switch is triggered. The second switch is used for controlling the counter to stop counting when the second switch is triggered.

### BACKGROUND OF THE INVENTION

1. Field of the Invention

The present invention relates to an intelligent screw supplier, and more particularly, to an intelligent screw supplier with auto-count and alarm function and method thereof.

2. Description of the Prior Art

When proceeding with an assembly operation of electronic products, specific mechanisms or components are fabricated by way of locking screws. For each component, the amount of screws that is needed is different. Because the position of each component is different, the distribution positions of these screws are different. Before an operator proceeds with an assembly operation, the amount and the distribution positions of the screws that are needed must be remembered. After that, screws are taken out and locked at fixed positions. Due to long working hours and tiredness leading to lower attention, there are screws forgotten to be locked or omitted from electronic products. If screws are forgotten to be locked, the internal part of electronic products may fall off easily. If screws are omitted from electronic products, this may cause the internal parts of electronic products to short circuit, or users may hear strange noise inside the electronic products when using the electronic products. For this reason, quality of electronic products is influenced seriously.

Please refer to FIG. 1 that is a diagram of a screw supply machine 10 according to the prior art. The screw supply machine 10 includes a screw trough 12, a plurality of screws 13, a vibration device 15, a screw output line 16 and a leaf spring 14. The screw trough 12 is used for putting the screws 13. Users can put the screws 13 into the fillister. The vibration device 15 is coupled to the screw trough 12 for guiding and arranging the screws 13 in order through vibrations. The screw output line 16 is coupled to the screw trough 12 (connected via the interior) for transmitting the screws 13 after being guided and arranged in order. The leaf spring 14 is coupled to the screw output line 16 for stopping the screws on the screw output line 16. Operators take out a screw from the screw supply machine 10 by sticking the screw with a screwdriver and drawing out the screw in the same direction as the screw output line 16. At this time, the leaf spring 14 returns to the original position and stops the screws on the screw output line 16 once again. Therefore, operators can take out the screws one by one.

After the operator takes out a screw from the screw supply machine 10, the screw is locked into the electronic product. When finishing operation, the electronic product is transmitted to a next working station and the same lock action is repeated on another electronic device. However, the screw supply machine 10 only provides guiding and arranging screws in order through vibrations by the vibration device 15. The screw supply machine 10 does not provide auto-count and alarm functions. Hence, the operator forgets to lock screws or omits screws from electronic products due to carelessness. This further influences manufacture quality.

### SUMMARY OF THE INVENTION

It is therefore an object of the present invention to provide an intelligent screw supplier with auto-count and alarm functions and method thereof to solve the above-mentioned problems.

According to the claimed invention, an intelligent screw supplier with auto-count and alarm functions is disclosed. The intelligent screw supplier operates with a first switch and a second switch. The intelligent screw supplier includes a screw supply machine and a screw supply controller. The screw supply machine is used for supplying screws. The screw supply controller includes a counter and a logic judgment device. The counter is used for calculating an amount of screws supplied by the screw supply machine. The logic judgment device is used for comparing the amount of screws calculated by the counter with a predetermined amount. The first switch is used for controlling the counter to start counting when the first switch is triggered. The second switch is used for controlling the counter to stop counting when the second switch is triggered.

According to the claimed invention, an intelligent screw supplier with auto-count and alarm functions is disclosed. The intelligent screw supplier includes a screw supply machine, a screw supply controller, a first switch, and a second switch. The screw supply machine includes an output end for outputting an output signal. The screw supply machine is used for guiding and arranging screws in order. The screw supply controller includes a counter and a logic judgment device. The counter includes a first input end for receiving an input switch signal, a second input end for receiving an output switch signal, a third input end coupled to the output end of the screw supply machine for receiving the output signal, and an output end for outputting a first screw amount. The logic judgment device includes a first input end for receiving the input switch signal, a second input end for receiving the output switch signal, a third input end coupled to the output end of the counter for receiving the first screw amount, a fourth input end for receiving a predetermined amount, and an output end for outputting an alarm signal. The logic judgment device is used for determining whether to output the alarm signal according to signals received by the third and the fourth input ends. The first switch includes an output end coupled to the screw supply controller for outputting the input switch signal. The second switch includes an output end coupled to the screw supply controller for outputting the output switch signal.

According to the claimed invention, a method of an intelligent screw supplier for dealing with screw supply quantities is disclosed. The method includes using a screw supply machine to supply screws, controlling a counter to start counting an amount of screws supplied by the screw supply machine when a first switch is triggered, controlling the counter to stop counting the amount of screws supplied by the screw supply machine when a second switch is triggered, and comparing the amount of screws counted by the counter after counting with a predetermined amount.

In an embodiment of the present invention, the screw supply machine includes a screw trough, a vibration device, a screw output line and a leaf spring. The screw trough is used for putting screws. The vibration device is used for guiding and arranging screws in order through vibrations. The screw output line is used for transmitting the screws after being guided and arranged in order. The leaf spring is used for outputting the screws transmitted from the screw output line one by one.

In an embodiment of the present invention, the first switch and the second switch are contact switches or infrared ray sensors.

In an embodiment of the present invention, the intelligent screw supplier further includes an input device for inputting the predetermined amount. The input device could be a keyboard or touch panel.

In an embodiment of the present invention, the intelligent screw supplier further includes a display for displaying an amount counted by the counter or displaying the predetermined amount. The display device could be a liquid crystal display (LCD), a light emitting diode monitor (LED monitor) or an Organic Light Emitting Display (OLED).

In an embodiment of the present invention, the intelligent screw supplier further includes an alarm device for generating an alarm signal if the amount counted by the counter when stopping counting is not equal to the predetermined amount.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a screw supply machine according to the prior art.

FIG. 2 is a diagram of an intelligent screw supplier according to an embodiment of the present invention.

FIG. 3 is a diagram of an operation procedure in an operation station according to an embodiment of the present invention.

FIG. 4 is a diagram of a flow illustrating an intelligent screw supplier dealing with screw supply quantities.

### DETAILED DESCRIPTION

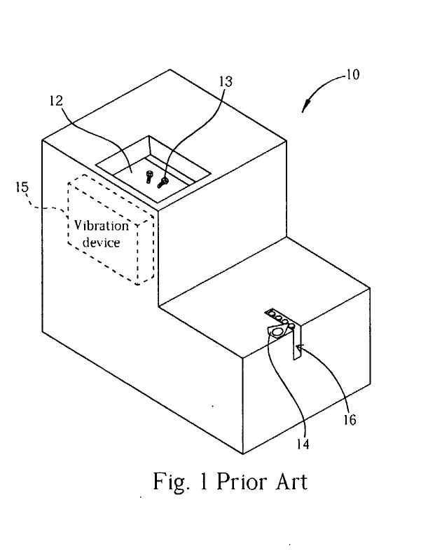

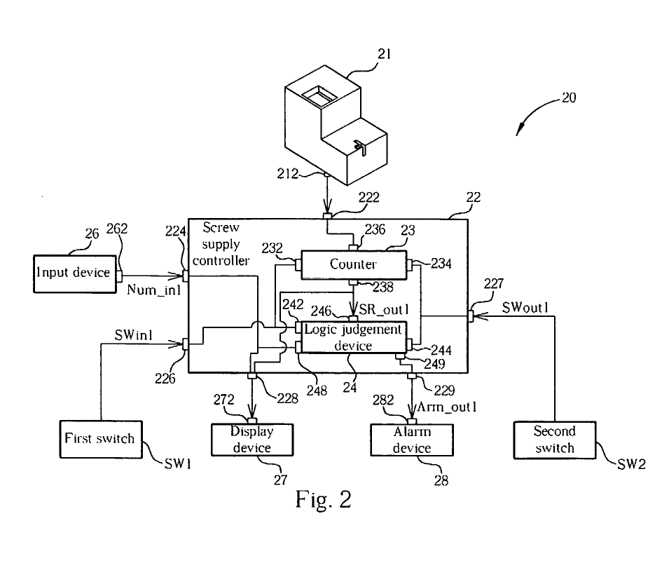

Please refer to FIG. 2 that is a diagram of an intelligent screw supplier 20 according to an embodiment of the present invention. The intelligent screw supplier 20 includes a screw supply machine 21, a screw supply controller 22, a first switch SW1, a second switch SW2, an input device 26, a display device 27, and an alarm device 28. The screw supply machine 21 includes an output end 212 used for outputting an output signal. Except for the modifications disclosed by the embodiment, the screw supply machine 21 is a traditional screw supplier commonly seen in market conditions such as the screw supply machine 10 in FIG. 1. Therefore, complete and explicit details of the screw supplier are known to those skilled in the art and need not be repeated here. The screw supply machine 21 is used for guiding and arranging screws in order.

In this embodiment, the screw supply controller 22 is a control printed circuit board that is installed outside the screw supply machine 21. In other embodiments, the screw supply controller 22 could be an independent device and is coupled to the screw supply machine 21 through wirings. Certainly, the screw supply controller 22 can be installed inside the screw supply machine 21.

The screw supply controller 22 described above includes a counter 23, a logic judgment device 24, a first input end 222, a second input end 224, a third input end 226, a fourth input end 227, a first output end 228, and a second output end 229. The first input end 222 is coupled to the output end 212 of the screw supply machine 21 for receiving the output signal. The second input end 224 is coupled to an output end 262 of the input device 26. The third input end 226 is coupled to the first switch SW1 for receiving an input switch signal SWin1. The fourth input end 227 is coupled to the second switch SW2 for receiving an output switch signal SWout1. The first output end 228 is coupled to an input end 272 of the display device 27. The second output end 229 is coupled to an input end 282 of the alarm device 28.

The counter 23 described above includes a first input end 232, a second input end 234, a third input end 236, and an output end 238. The first input end 232 is coupled to the first switch SW1 for receiving the input switch signal SWin1. The second input end 234 is coupled to the second switch SW2 for receiving the output switch signal Swout1. The third input end 236 is coupled to the output end 212 of the screw supply machine 21 for receiving the output signal. The output end 238 is used for outputting a first screw amount SR_out1.

The logic judgment device 24 described above includes a first input end 242, a second input end 244, a third input end 246, a fourth input end 248, and an output end 249. The first input end 242 is coupled to the first switch SW1 for receiving the input switch signal SWin1. The second input end 244 is coupled to the second switch SW2 for receiving the output switch signal SWout1. The third input end 246 is coupled to the output end 238 of the counter 23 for receiving the first screw amount SR_out1. The fourth input end 248 is used for receiving a predetermined amount Num_in1. The output end 249 is coupled to the input end 282 of the alarm device 28 for outputting an alarm signal Arm_out1. The logic judgment device 24 is used for determining whether to output the alarm signal Arm_out1 according to signals received by the third input end 246 and the fourth input end 248.

Please continue to refer to FIG. 2. The first switch SW1 includes an output end coupled to the third input end 226 of the screw supply controller 22. The first switch SW1 is used for outputting the input switch signal SWin1. The second switch SW2 includes an output end coupled to the fourth input end 227 of the screw supply controller 22. The second switch SW2 is used for outputting the output switch signal SWout1. The input device 26 includes an output end 262 coupled to the second input end 224 of the screw supply controller 22 for inputting the predetermined amount Num_in1 to the screw supply controller 22. The display device 27 includes an input end 272 coupled to the first output end 228 of the screw supply controller 22. The display device 27 is used for displaying the predetermined amount Num_in1 set by the input device 26 or the amount counted by the counter 23 (including the first screw amount SR_out1).

The alarm device 28 includes an input end 282 coupled to the second output end 229 of the screw supply controller 22. The alarm device 28 is used for receiving the alarm signal Arm_out1 if the first screw amount SR_out1 is not equal to the predetermined amount Num_in1. The alarm device 28 can issue an alarm in any way, preferably by a flashing light or ring. The alarm device 28 can be an alarm ringer or a light bulb.

Moreover, in this embodiment, the first switch SW1 and the second switch SW2 can each be a contact switch, such as a button or a weight sensor. In other embodiments, the first switch SW1 and the second switch SW2 can each be a non-contact switch, such as an infrared ray sensor. In this embodiment, the input device 26 is a keyboard. In other embodiments, the input device 26 can be a touch panel or other input devices. In this embodiment, the display device 27 is a light emitting diode monitor (LED monitor). In other embodiments, the display device 27 can be a liquid crystal display (LCD).

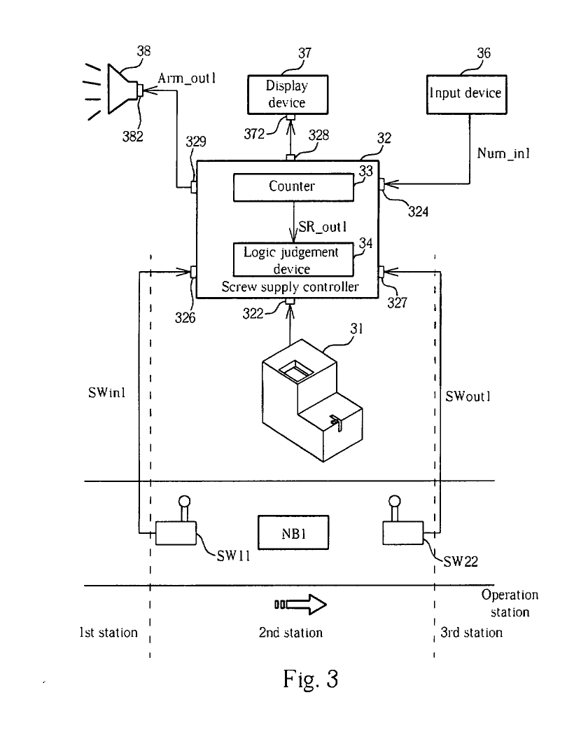

Please refer to FIG. 3. FIG. 3 is a diagram of an operation procedure in an operation station according to a preferred embodiment of the present invention. The connection of the components in FIG. 3 is described summarily as follows. The screw supply controller 32 includes a counter 33 and a logic judgment device 34. The screw supply controller 32 includes a first input end 322, a second input end 324, a third input end 326, a fourth input end 327, a first output end 328, and a second output end 329. The first input end 322 is coupled to a screw supply machine 31. The second input end 324 is coupled to an input device 36. The third input end 326 is coupled to a first switch SW11. The fourth input end 327 is coupled to a second switch SW22. The first output end 328 is coupled to an output end 372 of the display device 27. The second output end 329 is coupled to an output end 382 of an alarm device 38.

Please continue to refer to FIG. 3. The operator first inputs the amount of screws to be locked (the predetermined amount Num_in1) to the screw supply controller 32 through the input device 36. As shown in FIG. 3, a notebook NB1 is receiving a screw-lock operation at the 2^{nd} station. When entering the 2^{nd} station, the notebook NB1 touches the first switch SW11 first. At this moment, the first switch SW11 sends an input switch signal SWin1 to the screw supply controller 32. Thus the counter 33 inside the screw supply controller 32 starts to count.

Every time the operator takes out a screw from the screw supply machine 31, a sensor informs the screw supply machine 31 that a screw has been removed. For example, the sensor is coupled to the leaf spring of the screw supply machine 31. By this way, the operator taking out a screw leads to leaf spring action. The sensor senses the action and makes the screw supply machine 31 output an output signal to the counter 33 inside the screw supply controller 32. The counter 33 is incremented by one every time when the counter receives the output signal. In other embodiments, the sensor can be installed in an exit of the screw output line of the screw supply machine 31. Every time when the operator takes out a screw, the sensor is informed that a screw is taken out by way of changing light values.

When leaving the 2^{nd} station, the notebook NB1 touches the second switch SW22. At this moment, the second switch SW22 sends an output switch signal SWout1 to the screw supply controller 32. Thus the counter 33 inside the screw supply controller 32 stops counting. The counter 33 then sends the amount counted by the counter 33 when stopped counting (the first screw amount SR_out1) to the logic judgment device 34 inside the screw supply controller 32.

At this moment, the logic judgment device 34 inside the screw supply controller 32 compares the first screw amount SR_out1 with the predetermined amount Num_in1 to determine whether to output an alarm signal Arm_out1. If the first screw amount SR_out1 is not equal to the predetermined amount Num_in1, the logic judgment device 34 sends the alarm signal Arm_out1 to the alarm device 38. Hence, the alarm device 38 issues an alarm. The alarm device 38 can issue the alarm by way of a flashing light or audible tone. If the first screw amount SR_out1 is equal to the predetermined amount Num_in1, the logic judgment device 34 will not send the alarm signal Arm_out1 to the alarm device 38 so the alarm device 38 will not react. Therefore the notebook NB1 enters into the 3^{rd} station successfully. The operator finishes screw-lock operation.

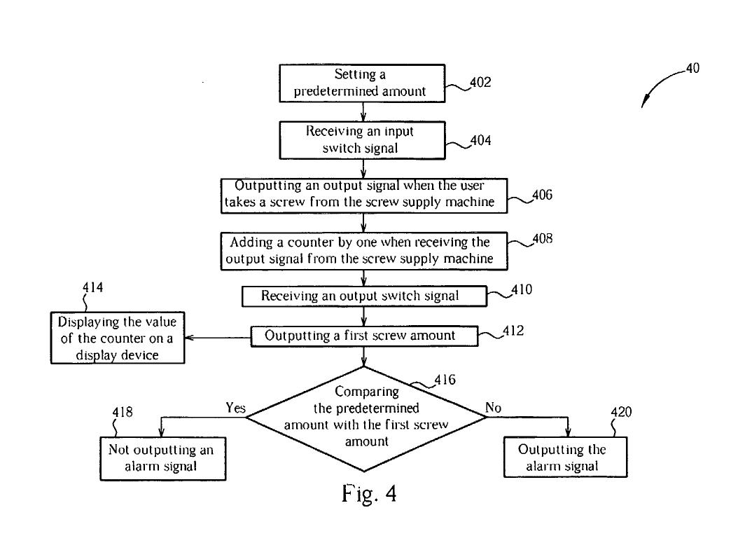

Please refer to FIG. 4. FIG. 4 is a diagram of a flow 40 illustrating an intelligent screw supplier dealing with screw supply quantities. The flow 40 includes the following steps:

Step 402: Setting a predetermined amount.

Step 404: Receiving an input switch signal.

Step 406: Outputting an output signal when the operator takes out a screw from the screw supply machine.

Step 408: Adding to a counter by one every time when receiving the output signal from the screw supply machine.

Step 410: Receiving an output switch signal.

Step 412: Outputting a first screw amount.

Step 414: Displaying the value of the counter on a display device.

Step 416: Comparing the predetermined amount with the first screw amount.

Step 418: Not outputting an alarm signal if the predetermined amount is equal to the first screw amount.

Step 420: Outputting the alarm signal if the predetermined amount is not equal the first screw amount.

In step 402, the operator set the predetermined amount first. In step 406-408, every time when the operator takes out a screw from the screw supply machine, the counter is incremented by one. In step 416, the predetermined amount is compared with the first screw amount. If the predetermined amount is equal to the first screw amount, no alarm signal is issued. Otherwise, output the alarm signal.

The above-mentioned embodiments illustrate but do not limit the present invention. The mentioned alarm device 28 and 38 are not restricted to light bulbs or alarm rings only, it could be other type alarm device. The first switch SW1 and SW11 and the second switch SW2 and SW22 could be a contact switch or a non-contact switch individually but are not restricted to embodiments mentioned in the present invention. The input device 26 and 36 could be other type input device. The display device 27 could be other type display. The counter may alternatively be decremented each time the output signal from the screw supply machine is received. Furthermore, the logic judgment device 24 and 34 can be implemented by software program not limit to hardware only.

In conclusion, the present invention provides an intelligent screw supplier with auto-count and alarm functions. When the amount of screws taken is not equal to the predetermined amount, the alarm device will inform the operator to pay attention to the problems of forgetting to lock screws or omitting screws in electronic products. In this way, the present invention provides an intelligent screw supplier to solve the above-mentioned problems. Thus, manufacturing quality can be improved.

Those skilled in the art will readily observe that numerous modifications and alterations of the device and method may be made while retaining the teachings of the invention.

What is claimed is:

1. An intelligent screw supplier with auto-count and alarm function, the intelligent screw supplier cooperating with a first switch and a second switch, the intelligent screw supplier comprising:
a screw supply machine for supplying screws; and
a screw supply controller comprising:
a counter for calculating an amount of screws supplied by the screw supply machine; and
a logic judgment device for comparing the amount of screws calculated by the counter with a predetermined amount;
wherein the first switch is used for controlling the counter to start counting when the first switch is triggered and the second switch is used for controlling the counter to stop counting when the second switch is triggered.

2. The intelligent screw supplier of claim 1 wherein the screw supply machine further comprises:
a screw trough for putting screws;
a vibration device for guiding and arranging screws in order through vibrations;
a screw output line for transmitting the screws after being guided and arranged in order; and
a leaf spring for outputting the screws transmitted from the screw output line one by one.

3. The intelligent screw supplier of claim 1 wherein the first switch and the second switch are contact switches or infrared ray sensors.

4. The intelligent screw supplier of claim 1 further comprising an input device for inputting the predetermined amount.

5. The intelligent screw supplier of claim 1 further comprising a display device for displaying an amount counted by the counter.

6. The intelligent screw supplier of claim 1 further comprising a display device for displaying the predetermined amount.

7. The intelligent screw supplier of claim 1 further comprising an alarm device for generating an alarm signal if the amount counted by the counter when stopping counting is not equal to the predetermined amount.

8. An intelligent screw supplier with auto-count and alarm function comprising:
a screw supply machine having an output end for outputting an output signal, the screw supply machine used for guiding and arranging screws in order;
a screw supply controller comprising:
a counter having a first input end for receiving an input switch signal, a second input end for receiving an output switch signal, a third input end coupled to the output end of the screw supply machine for receiving the output signal, and an output end for outputting a first screw amount; and
a logic judgment device having a first input end for receiving the input switch signal, a second input end for receiving the output switch signal, a third input end coupled to the output end of the counter for receiving the first screw amount, a fourth input end for receiving a predetermined amount, and an output end for outputting an alarm signal, the logic judgment device used for determining whether to output the alarm signal according to signals received by the third and the fourth input ends;
a first switch having an output end coupled to the screw supply controller for outputting the input switch signal; and
a second switch having an output end coupled to the screw supply controller for outputting the output switch signal.

9. The intelligent screw supplier of claim 8 wherein the screw supply machine further comprises:
a screw trough for putting screws;
a vibration device for guiding and arranging screws in order through vibrations;
a screw output line for transmitting the screws after being guided and arranged in order; and
a leaf spring for outputting the screws transmitted from the screw output line one by one.

10. The intelligent screw supplier of claim 8 wherein the first switch and the second switch are contact switches or infrared ray sensors.

11. The intelligent screw supplier of claim 8 further comprising an input device for inputting the predetermined amount.

12. The intelligent screw supplier of claim 8 further comprising a display device for displaying an amount counted by the counter.

13. The intelligent screw supplier of claim 8 further comprising a display device for displaying the predetermined amount.

14. The intelligent screw supplier of claim 8 further comprising an alarm device for generating the alarm signal if the amount counted by the counter when stopping counting is not equal to the predetermined amount.

15. A method of an intelligent screw supplier dealing with screw supply quantity comprising:
using a screw supply machine to supply screws;
controlling a counter to start counting an amount of screws supplied by the screw supply machine when a first switch is triggered;
controlling the counter to stop counting the amount of screws supplied by the screw supply machine when a second switch is triggered; and
comparing the amount of screws counted by the counter after counting with a predetermined amount.

16. The method of claim 15 further comprising generating an alarm signal if the amount counted by the counter when stopping counting is not equal to the predetermined amount.

17. The method of claim 15 further comprising displaying an amount counted by the counter.

18. The method of claim 15 further comprising displaying the predetermined amount.

19. The method of claim 15 further comprising inputting the predetermined amount.
